(19) United States
(12) Patent Application Publication
(10) Pub. No.: US 2005/0035858 A1
(43) Pub. Date: Feb. 17, 2005

(54) Monitoring system

(76) Inventor: Yi-Chuan Liu, Taipei County (TW)

Correspondence Address: Yi-Chuan Liu, 7F., No. 213 Civic Boulevard. Sec. 4, Taipei, 105, TW

(21) Appl. No.: 10/638,939

(22) Filed: Aug. 12, 2003

(51) Int. Cl. G08B 13/00

(52) U.S. Cl. 340/541; 348/152

(57) ABSTRACT

A monitoring system includes a digital image-taking apparatus and a sensing unit. The sensing unit detects any moving object within a monitored area and sends an image-taking signal to a processing unit of the digital image-taking apparatus for the same to take or record pictures of the monitored area. A timing unit adds time indications to the pictures taken or recorded by the digital image-taking apparatus before a memory unit stores digital image signals of the taken or recorded pictures. With the above arrangements, setup cost for the monitoring system and space for storing the images may be largely reduced, and unnecessary waste of useless recording may be avoided.

### FIELD OF THE INVENTION

The present invention relates to a monitoring system, and more particularly to a monitoring system that is applicable for taking or recording images of a moving object.

### BACKGROUND OF THE INVENTION

Monitoring systems are often mounted in general stores, shopping malls, apartments, buildings, and entrances of some roads or alleys in a community for recording and monitoring such places on a long-term basis, so that immediate and effective measures may be taken against any accident or unexpected event occurred within the monitored areas, or evidences may be stored for search in the future.

FIG. 1 is a schematic system diagram of a conventional monitoring system. As shown, the conventional monitoring system substantially includes a plurality of cameras 1, video recorders 2, and monitors 3. Taking a monitoring system for an office building as an example, the multiple cameras 1 may be separately mounted at the building entrance, elevators, stairs, passages, machine rooms, warehouses, etc., and electrically connected to corresponding video recorders 2 located at a monitoring center, such as a monitoring/control room, a guardhouse, etc. The multiple video recorders 2 are then connected to a controller 31 to output video signals to the multiple monitors 3.

The number of the video recorders 2 may be the same as that of the video cameras 1. However, since there may be interrupted images due to change of videotapes when a video home system (VHS) tape is used, it is a common practice in situations that require complete video recording for safety and security purpose to provide the video recorders 2 twice as many as the cameras 1. That is, two sets of video recorders 2 are alternately used to record images taken with each camera 1, and a switch 21 is provided to switch operations between the two video recorders 2.

The number of the monitors 3 is usually less than that of the cameras 1. For example, one monitor 3 may have four split screens to simultaneously show the images from four different cameras 2. A controller 31 or allocator is provided between the video recorders 2 and the monitors 3 to implement the collecting, outputting, and switch controlling of video signals.

The above-described conventional monitoring system has the following disadvantages:
1. Since each one camera 1 must have one or two video recorders 2 to work with it, a considerably high cost for providing the whole monitoring system is required.
2. The multiple sets of video recorders 2 and corresponding switches 21 complicate and accordingly increase the cost for the wiring of the monitoring system.
3. A large quantity of videotapes must be used and stored for a fixed period, such as one week, two weeks, one month, etc. Extra costs and space for the videotapes and efforts for sorting the stored videotapes are required.
4. The playback of videotapes must be done with a video recorder or a video player, and it is inconvenient to do so.
5. It forms a waste to continuously record images of some places, such as machine rooms, warehouses, or some other place at nighttime that have fixed angle of view and have low frequency of passage by people, because it is very possible most parts of these videotapes show fixed and similar pictures and are therefore useless.

It is therefore tried by the inventor to develop a monitoring system based on a novel and improved monitoring concept to take or record only pictures of a moving object within a monitored area, and data of images taken or recorded by a camera are digitally stored in a memory card or a hard disk of a computer system, so as to overcome drawbacks existed in the conventional monitoring system.

### SUMMARY OF THE INVENTION

A primary object of the present invention is to provide a monitoring system that has integrated functions of image-taking, recording, and digital storage of recorded data, and is adapted to take or record images only when a moving object is detected in the monitored area.

To achieve the above and other objects, the monitoring system of the present invention includes a digital image-taking apparatus and a sensing unit.

The digital image-taking apparatus is adapted to output video signals to an externally connected monitor for monitoring and controlling purpose, and includes a processing unit, to which at least a control unit, a memory unit, an image-taking unit, and a timing unit are connected.

The sensing unit is electrically connected to the processing unit for detecting any moving object within a monitored area and sending an image-taking signal to the processing unit of the digital image-taking apparatus for the same to take or record pictures of the monitored area when a moving object is detected. The timing unit adds time indications to the pictures taken or recorded by the digital image-taking apparatus before the memory unit stores digital image signals of the taken or recorded pictures.

With the above arrangements, setup cost for the monitoring system and space for storing the recorded images may be largely reduced, and unnecessary waste of useless recording may be avoided.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a schematic system diagram of a conventional monitoring system; and

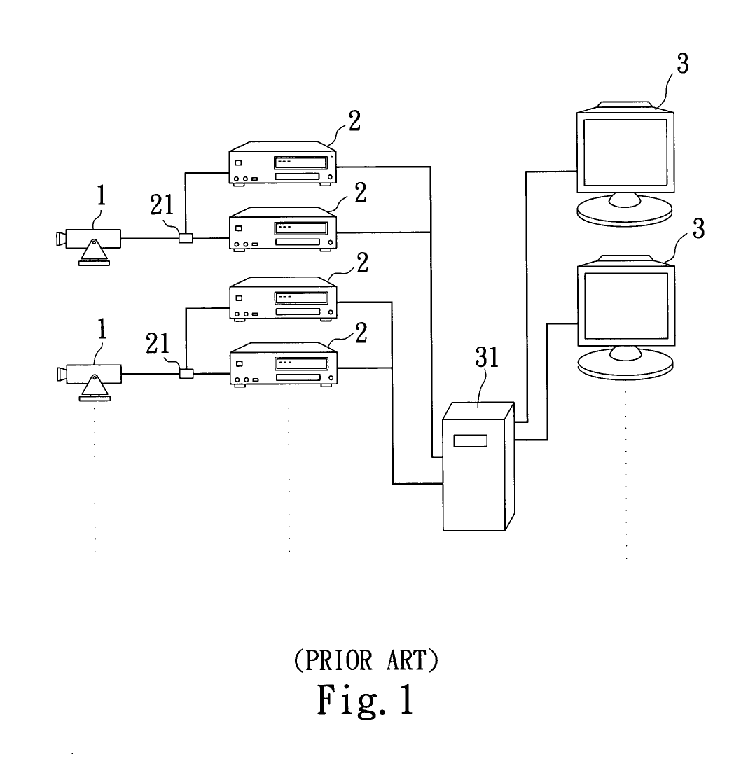

FIG. 2 is a block diagram of a monitoring system according to the present invention.

### DETAILED DESCRIPTION OF THE PREFERRED EMBODIMENTS

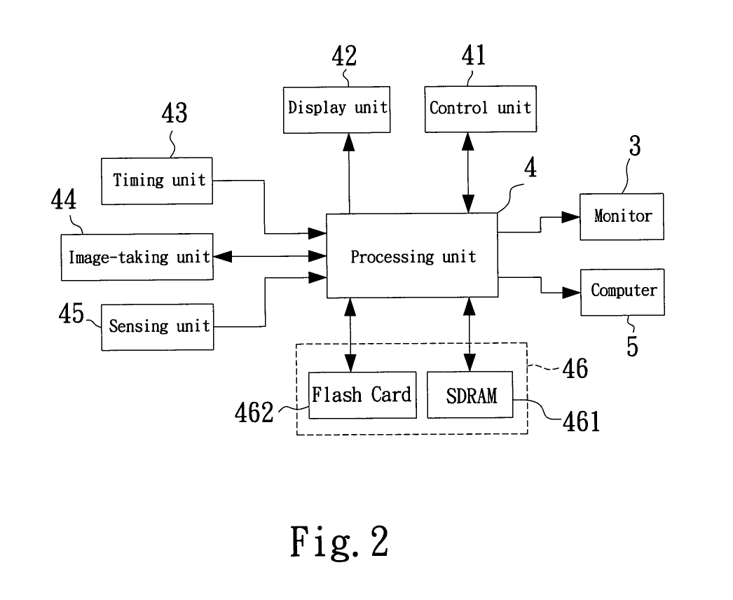

Please refer to FIG. 2 that is a block diagram of a monitoring system according to the present invention. As shown, the monitoring system mainly includes a processing unit 4, to which a control unit 41, a display unit 42, a timing unit 43, an image-taking unit 44, a sensing unit 45, and a memory unit 46 are connected.

The processing unit 4 is a processor adapted to handle data operation, reading, writing, etc.

The control unit 41 is an operational interface including several control keys adapted to control different modes in which the processing unit works.

The display unit 42 is a liquid crystal display (LCD) for displaying control pictures in response to the control unit 41.

The timing unit 43 is a real-time clock for providing real-time time signals.

The image-taking unit 44 is adapted to take or record pictures within a monitored area to obtain image signals. The image-taking unit 44 may be, for example, a Complementary Metal-Oxide Semiconductor (CMOS) lens.

The sensing unit 45 includes a passive infrared sensor and an operation amplifier for detecting moving objects within the monitored area and sending a signal to the processing unit 4 when a moving object is detected.

The memory unit 46 includes a synchronous dynamic random access memory (SDRAM) 461 and a Flash Card 462 to serve as a buffer and a register, respectively. The memory unit 46 is also used to store digital image signals obtained by the image-taking unit 44 on a long-term basis.

The above-described monitoring system may be mounted at a selected place to be monitored. The control unit 41 and the display unit 42 may then used to set and control the mode in which the image signals are taken, so that the monitoring system automatically takes photos or proceeds with video recording when any moving object appears within the area or place under monitor. The digital image signals so obtained are added with real-time time information and then stored in the Flash Card 462. The modes of photographing or video recording that may be set via the control unit 41 include, for example, continuously taking one or more sheets of pictures, or video recording for a period of time. It is also possible to set the time format or whether the time information is added to the pictures.

The passive infrared sensor included in the sensing unit 45 is adapted to trigger a signal through sensing any movement of a heat source. The operation amplifier amplifies the signal from the passive infrared sensor and sends an image-taking signal to the processing unit 4 for the latter to control the image-taking unit 44 to take or record pictures in a preset photographing or video recording mode. Alternatively, the processing unit 4 may output video signals to an externally connected monitor 3, such as a TV screen, to enable a real-time monitoring. However, it is not necessary for the monitoring system to take or record pictures all the time. That is, a real-time display of images of the monitored place may be directly monitored via the externally connected monitor 3, and the monitoring system may still be set to take or record pictures only when any moving object within the monitored place is detected. In this manner, the monitoring system of the present invention is superior to the conventional monitoring systems and has the following advantages:
1. The monitoring system of the present invention may be set up with relative low cost because it is not necessary to include a number of video recorders in the monitoring system. Moreover, since the number of monitoring apparatus to be provided corresponds to the designed quantity of points to be monitored; setup cost for the whole monitoring system may be relatively reduced.
2. Since only one monitoring apparatus is set up for one monitored point, wiring for the monitoring system is simplified and cost for wiring is lowered.
3. Since only the digital image signals are stored, and the storage for the monitoring system may be a flash card, such as Smart Media Card, Compact Flash Card, etc. that has small volume but large storage capacity, only a small quantity of memory cards are needed to store image data to be kept within a fixed term, such as one week, two weeks, or one month. Alternatively, the digital image signals may be recorded on a compact disk. Therefore, a relatively low cost is needed for storage media used in the monitoring system of the present invention.
4. It is more general to use memory cards. However, the monitoring system of the present invention also allows external connection to a computer 5 to directly download the image signals to a storage medium of the computer, such as a hard disk, so that the stored image data may be conveniently used.
5. For some places that may be monitored at a fixed angle of view and have a low frequency of passage by people, such as a machine room, a warehouse, or some other place at night time, the system may be set to take or record pictures only when there is any moving object appeared in the monitored place. Therefore, unnecessary waste of useless recording may be avoided.

In the above-described embodiment, the processing unit 4 of the monitoring system is not limited to external connection to the monitor 3, but may be externally connected to only one set of computer system 5 that has image processing software adapted to process the taken or recorded pictures and output or display the image signals on a monitor of the computer system to achieve the same function of real-time monitoring. That is, in the practical implementation of the present invention, the image signals are not necessarily output directly to the monitor 3, but may be indirectly output to the monitor 3 via a mainframe of the computer system. More specifically, the monitor 3 may be a TV screen or a computer screen.

1. A monitoring system, comprising:
a digital image-taking apparatus adapted to output video signals to an externally connected monitor for monitoring purpose; said digital image-taking apparatus including a processing unit, to which at least a control unit, a memory unit, an image-taking unit, and a timing unit are electrically connected; and
a sensing unit being electrically connected to said processing unit of said digital image-taking apparatus for detecting any moving object within an area to be monitored, and sending an image-taking signal to said processing unit for said digital image-taking apparatus to take or record picture or pictures of said moving object; and
said timing unit being adapted to add a time indication to said pictures having been taken or recorded, and said memory unit being adapted to store digital image signals of said pictures taken or recorded by said digital image-taking apparatus.

2. The monitoring system as claimed in claim 1, wherein said digital image-taking apparatus further includes a display electrically connected to said processing unit for displaying control pictures.

3. The monitoring system as claimed in claim 1, wherein said memory unit includes a register and a flash memory.

4. The monitoring system as claimed in claim 3, wherein said register is a random access memory.

5. The monitoring system as claimed in claim 3, wherein said flash memory is a flash card.

6. The monitoring system as claimed in claim 1, wherein said sensing unit includes a passive infrared sensor and an operation amplifier.

7. The monitoring system as claimed in claim 1, wherein said control unit is an operational interface including a plurality of control keys.

8. The monitoring system as claimed in claim 1, wherein said monitor is a TV screen.

9. The monitoring system as claimed in claim 1, wherein said monitor is a monitor connected to a mainframe of a computer system.

10. The monitoring system as claimed in claim 1, wherein said processing unit is externally connected to a computer system for storing digital image signals to a storage medium of said computer system.

11. The monitoring system as claimed in claim 10, wherein said storage medium is a hard disk.
